(19) United States
(12) Patent Application Publication
(10) Pub. No.: US 2002/0100740 A1
(43) Pub. Date: Aug. 1, 2002

(54) Gantry with boom crane

(76) Inventor: Robert S. Amoss, New Orleans, LA (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002

(21) Appl. No.: 10/016,169

(22) Filed: Nov. 30, 2001

Related U.S. Application Data
(60) Provisional application No. 60/310,593, filed on Aug. 7, 2001.
(60) Provisional application No. 60/270,334, filed on Feb. 21, 2001.
(60) Provisional application No. 60/250,053, filed on Nov. 30, 2000.

(51) Int. Cl. B66C 1/10

(52) U.S. Cl. 212/224

(57) ABSTRACT

The present invention combines a gantry crane (10) with one or more rotating boom cranes (11, 12, 17, 18) to increase cargo productivity economically. There can be two luffing boom cranes attached to the gantry and two slewing boom cranes attached to the gantry. One can retrofit an existing gantry by attaching a boom crane and frame to a ship-to-shore gantry.

### CROSS-REFERENCE TO RELATED APPLICATIONS

U.S. Provisional Patent Application Serial No. 60/310,593, filed Aug. 7, 2001, is incorporated herein by reference.

U.S. Provisional Patent Application Serial No. 60/270,334, filed Feb. 21, 2001, is incorporated herein by reference.

U.S. Provisional Patent Application Serial No. 60/250,053, filed Nov. 30, 2000, is incorporated herein by reference.

Priority of these three patent applications is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to cranes. More particularly, the present invention relates to gantry cranes.

2. General Background of the Invention

Cranes for transferring containers from ships include gantry cranes and boom cranes.

The following U.S. Patents are incorporated herein by reference: U.S. Pat Nos. 1,547,536; 3,586,152; 3,958,106; 4,666,341; 5,456,560; 5,478,181; 5,515,982; and 5,733,092.

### BRIEF SUMMARY OF THE INVENTION

The present invention is a gantry having one or more boom cranes The ability for a port to enhance all of its cargo vessel operations and particularly feeder and rail-on-dock operations by fitting existing or new ship-to-shore gantries with a boom crane is the primary benefit of the invention. The attached cranes can be considered a movable accessory thereby allowing the terminal operator to change the configuration of the gantry to optimize his cranes for different cargo operations, including containers, bulk, palletized and break bulk cargo.

The gantries of the present invention with boom cranes attached thereto have utility, for example, in terminals operating as transfer hubs for water-borne vessels, working from the transfer rack and the barges or small feeder ships on the back side of the platform or pier and larger ships on the ship side of the platform or pier.

A preferred embodiment of the present invention is apparatus including a gantry, a gantry crane attached to the gantry, and at least one rotating boom crane attached to the gantry. There can be at least two rotating boom cranes attached to the gantry. There is preferably at least one boom crane attached to the ship side of the gantry. There can be at least one boom crane attached to the back side of the gantry.

In one embodiment of the invention, there are three rotating boom cranes attached to the gantry. In one embodiment of the invention, there are four rotating boom cranes attached to the gantry. At least one of the boom cranes can be a rotating horizontal slewing boom crane

The gantry can be a ship-to-shore gantry. A boom crane and frame can be attached to the ship-to-shore gantry.

The apparatus of the present invention can include a boom crane, a frame for supporting the boom crane, and means for attaching the frame to a ship-to-shore gantry.

The boom crane in any embodiment could be a slewing boom crane attached to the gantry, or a luffing boom crane attached to the gantry.

In some embodiments, there can be at least one luffing boom crane attached to the gantry and at least one slewing boom crane attached to the gantry. In other embodiments, there can be two luffing boom cranes attached to the gantry and two slewing boom cranes attached to the gantry.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a plan view showing two gantries of the present invention;

FIG. 2 is a side elevational view showing a gantry of FIG. 1;

FIG. 3 is a plan view showing a gantry of the present invention with two attached boom cranes;

FIG. 4 is a side elevational view showing another embodiment of the present invention, a boom crane and frame attached to a new or existing ship-to-shore gantry;

FIG. 5 is a plan view showing the gantry and boom cranes of FIG. 4;

FIG. 6 is a front elevational view showing the gantry and boom cranes of FIG. 4;

FIG. 7 is a view similar to FIG. 6, but showing an embodiment of the invention including a rope luffing jib crane;

FIG. 8 is a plan view showing the gantry and boom cranes of FIG. 4 adjacent barges; and

FIG. 9 is a plan view showing the gantry of FIG. 4 adjacent barges, but with a single attached boom crane.

### DETAILED DESCRIPTION OF THE INVENTION

The present invention combines a gantry crane with one or more rotating boom cranes to increase cargo productivity economically.

The addition of one or two boom cranes to the ship side of the gantry allows a substantial increase in cargo productivity with a minimal cost.

Adding one or two boom cranes to the back side of a gantry will substantially increase the productivity of the gantry's ship unloading trolley. The increased reach of a boom allows terminal operators to efficiently load and unload barges, small feeder ships, trucks (terminal or road) and trains depending upon the terminal design.

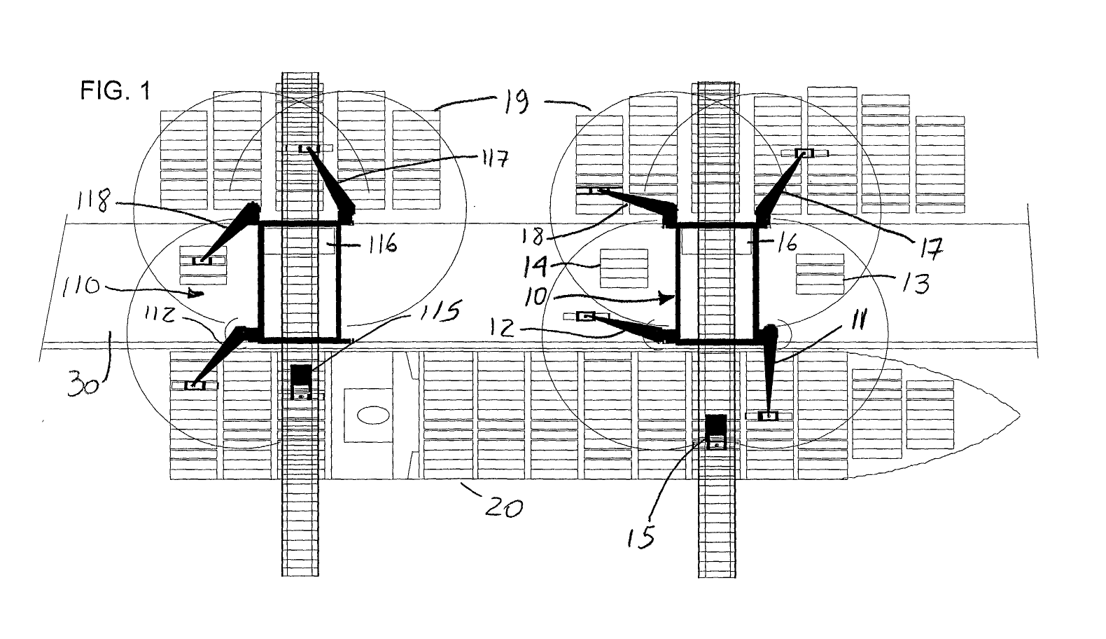

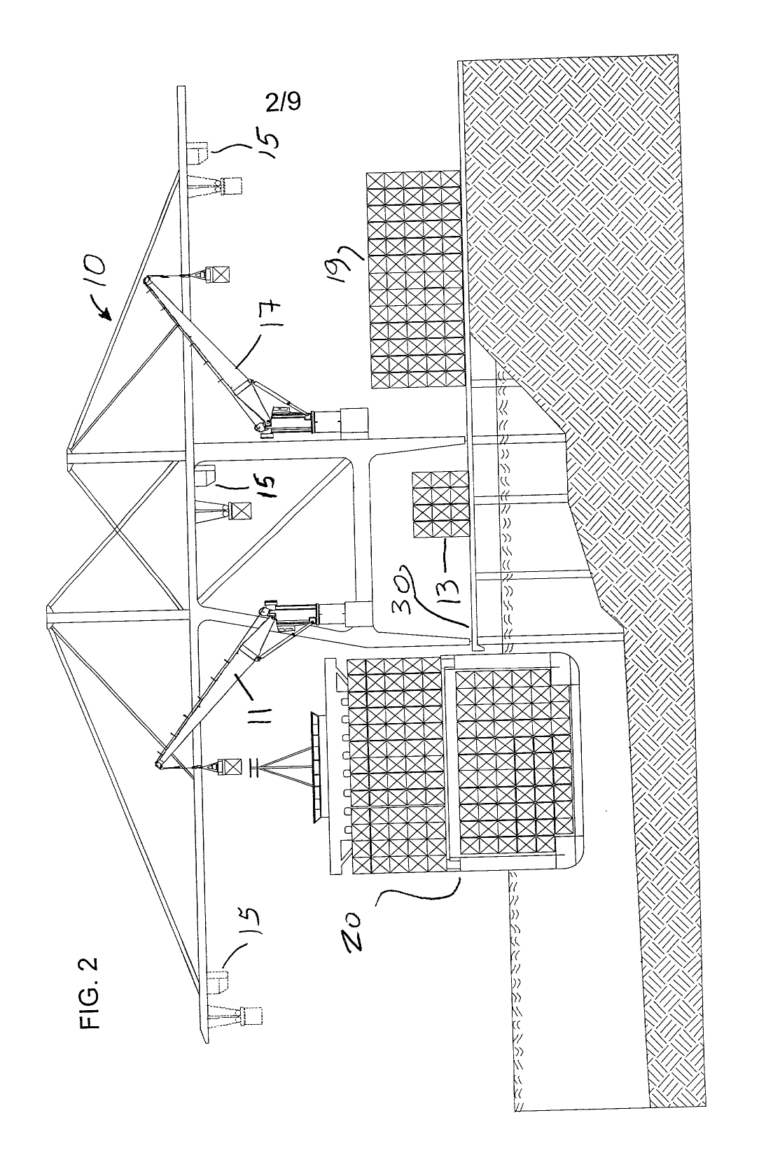

FIGS. 1 and 2 show a container vessel 20 along a dock 30 with two gantry cranes 10 and 110. Gantry 10 has two ship side boom cranes 11 and 12 working to and from transfer areas 13 and 14. Trolley 15 of gantry 10 works to and from the ship 20 and transfer rack 16. Back boom cranes 17 and 18 of gantry 10 work between transfer rack 16 and the container storage stack 19. Back boom cranes 17 and 18 also work between transfer areas 13 and 14 and the container storage stack 19. Operations of gantry 110 are similar, though as shown gantry 110 has a single ship side boom crane 112. Like gantry 10, gantry 110 has two back boom cranes 117 and 118. Trolley 115 and cranes 112, 117, and 118 all work with a transfer rack 116.

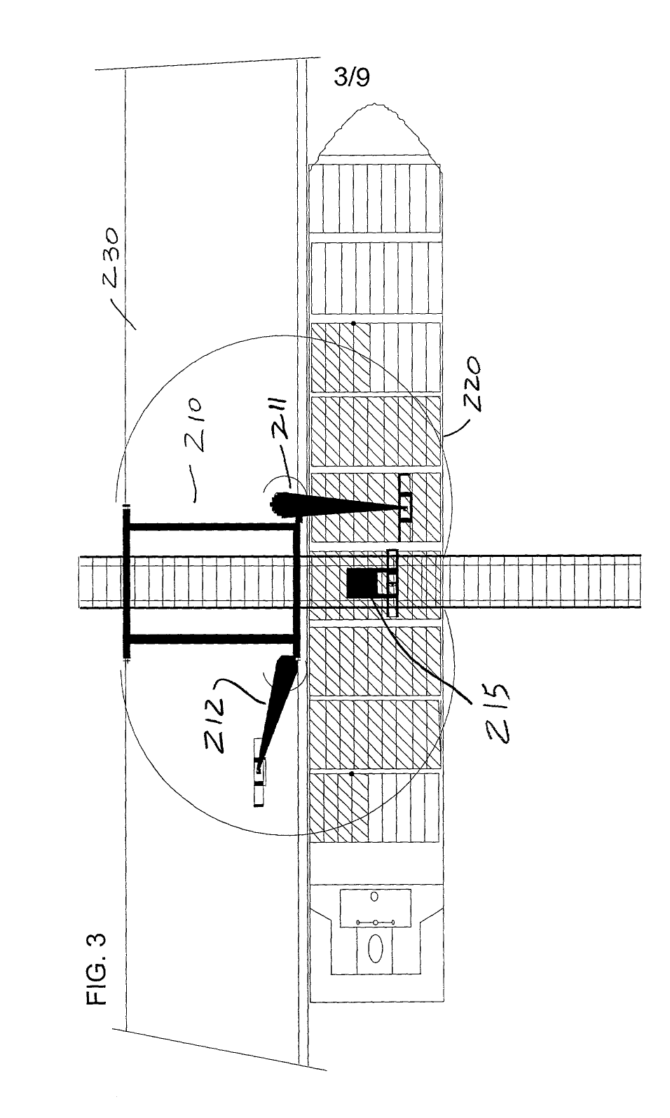

In some terminals, one might use gantries similar to gantries 10 and 110, but without back boom cranes (see gantry 210 in FIG. 3, showing two ship side boom cranes 211 and 212). In such a terminal, cargo transferred between vessel 220 and dock 230 might be handled with terminal tractors (not shown). Other vehicles such as AGV's (automated guided vehicles) and over-the-road approved trucks and trailer chassis can be used depending upon the terminal operations.

FIG. 3 shows a 9-container wide ship 220 with one gantry 210 configured with two ship-side boom cranes 211 and 212. Gantry 210 with two attached pedestal cranes 211 and 212 working a 9-container wide ship 220 gives simultaneous access to 53 cells versus a standard gantry's access of only 9 cells. Two standard gantries working as close as possible to each other cannot access the ship's bay between them without both cranes gantrying to new positions. The improved gantry 210 with two boom cranes 211 and 212 reaches seven adjacent bays without moving the gantry. A small terminal using the improved gantry 210 can handle ships efficiently and allow a more flexible ship stowage plan.

In FIG. 3, the hatched area shows a reach into 53 Cells on a 9-wide ship 220 using a 100′ (30.5 m) boom reach.

Gantry cranes similar to gantry cranes 10 and 110 might be used on a platform or finger pier handling cargo between ships (or larger barges) and feeder vessels or barges. In this example the terminal operates as a transfer hub for water born vessels, and the gantry cranes might each have a single ship side boom crane and two back boom cranes (the ship side boom cranes could be positioned distant from one another on the gantries).

Gantry cranes 10 and 110 might be used to transfer cargo between a dock and a container vessel along the dock In such a situation, gantry cranes 10 and 110 would work between a ship or barge and the storage stack, trucks and trains.

One or more of the boom cranes attached to the gantry cranes of the present invention can be horizontal slewing boom cranes (not shown in the drawings).

The examples mentioned herein show some of the benefits that can be achieved by combining a gantry with a boom crane. The examples do not show all of the possible applications. Some of the other possible benefits are for terminals that specialize in mixed cargo including containers, bulk and break bulk cargoes in bags, pallets, coils etc.

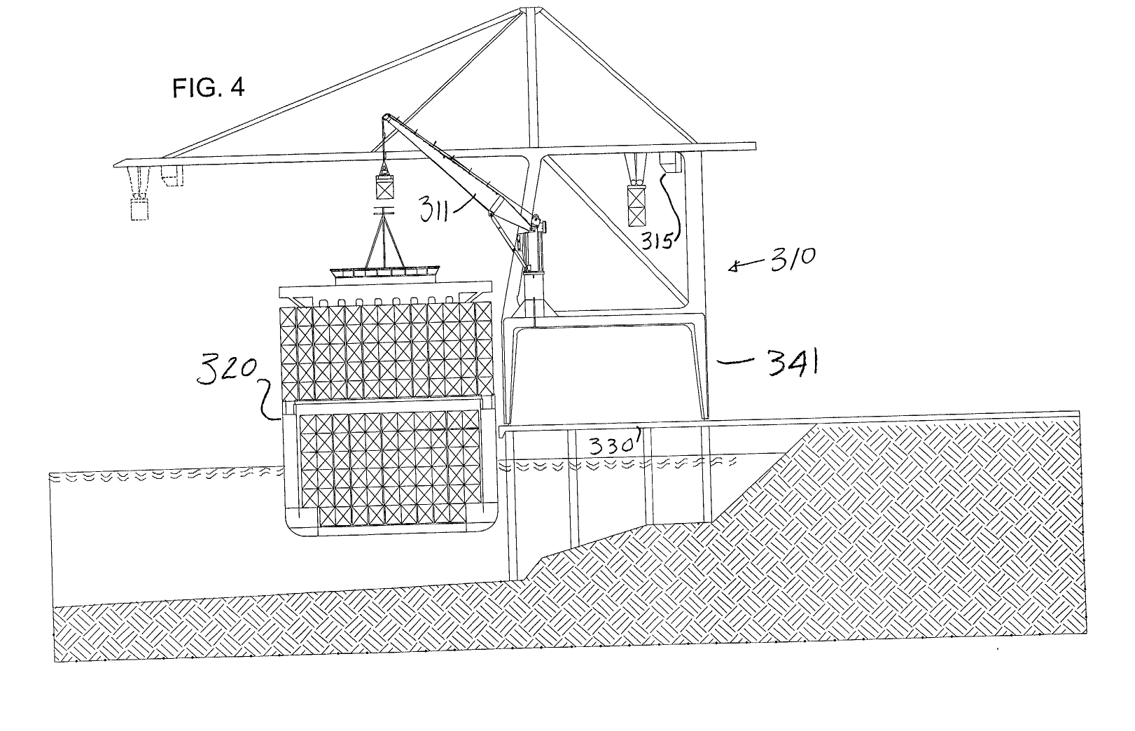

FIGS. 4-9 show an embodiment of the present invention, a boom crane and frame to be attached to a new or existing ship to shore gantry. This embodiment of the present invention allows the attachment of a boom crane to a new or existing gantry without substantially increasing wheel loads of the existing gantry. The boom cranes' stability benefits from the attachment. The invention shown in FIGS. 4-9 will allow the addition of one or two boom cranes to an existing gantry without significant structural change to the existing gantry and rail system. A conventional ship-to-shore gantry with one or more attached boom cranes increases cargo productivity economically and improves the efficiency of moving both containerized and non-containerized cargoes between vessels and land side truck/rail-on-dock transport at terminals. The invention improves the transfer of containers or other cargo between ships and feeder vessels or barges.

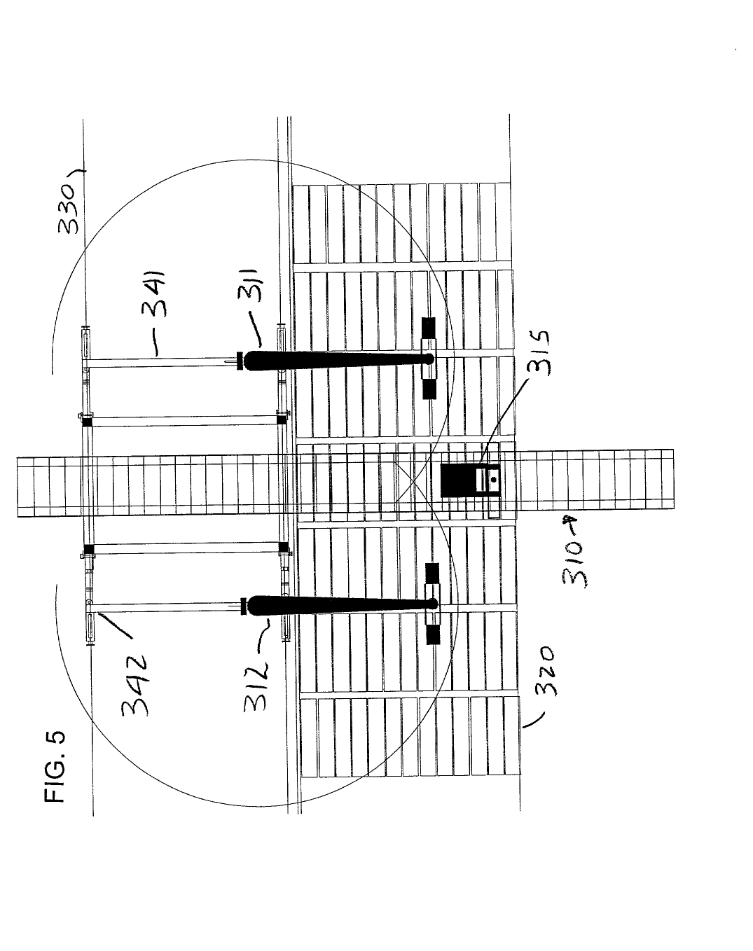

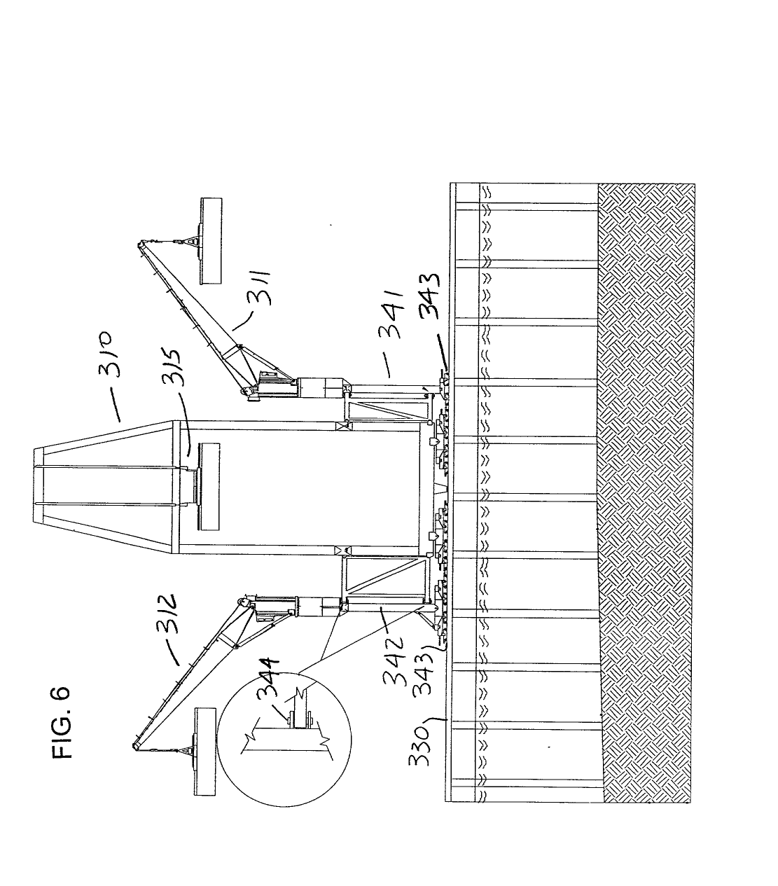

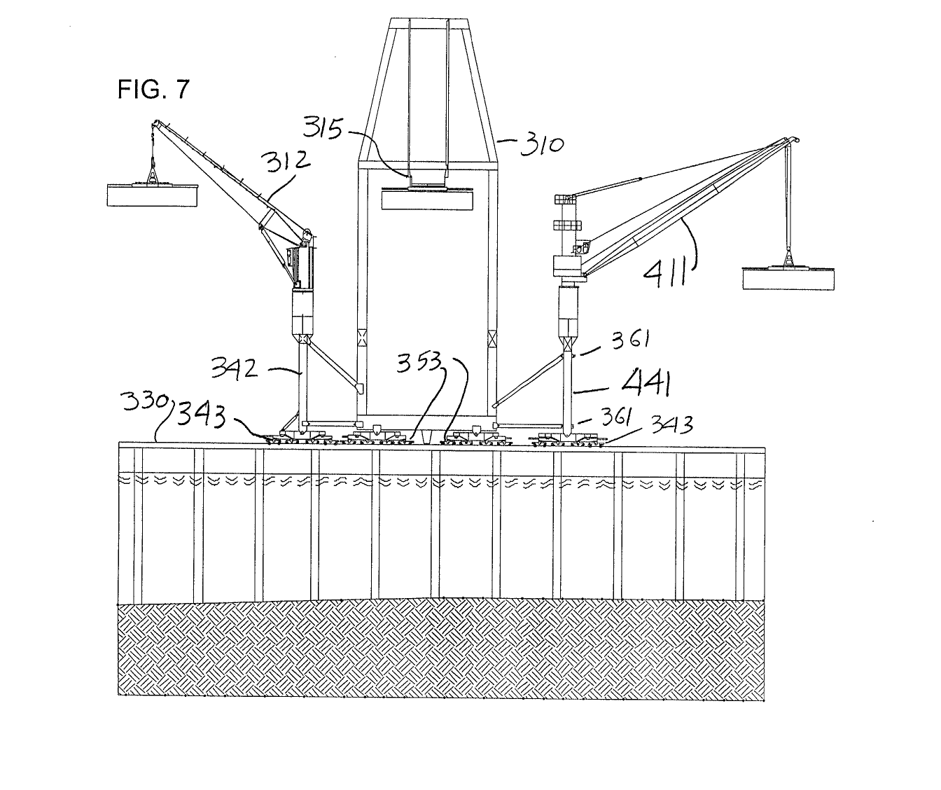

FIGS. 4 and 5 show a conventional ship-to-shore gantry 310 with two pedestal-type boom cranes 311 and 312 on separate frames 341 and 342 attached to the main gantry 310. Other boom cranes such as harbor cranes, jib cranes, telescopic and any other crane with a boom can be attached. The crane frames 341 and 342 can be (and preferably are) built to match the main gantry rail gauge and portal beam clearance. The wheels 343 (see FIGS. 6 and 7) of the boom crane frames 341 and 342 can be freewheeling. Hoist, luffing and sluing power for the attached cranes 311 and 312 can be provided in several ways. The main gantry power supply can be sized to provide the additional power needed for the attached cranes 311 and 312. The attached cranes 311 and 312 may also have a built in diesel/electric or diesel/hydraulic power system located over the back wheels of the crane frames 341 and 342. A separate cable reel or other power conveyance method can be used for the attached cranes 311 and 312 when power is supplied from a utility or a generating plant in the port area. A container ship 320 is shown in FIGS. 4 and 5. A trolley 315 is best seen in FIG. 4.

FIGS. 6 and 7 show different methods used to attach the crane frames 341,342 to the main gantry 310. The attachment points can be built on both sides of the frame 341, 342 (FIG. 7) and on the main gantry 310 thereby allowing a crane to be moved and attached to either side of a gantry 310. The design will be engineered to distribute the attached crane weight to the separate crane frame wheels 343 without adding significant weight to the main gantry wheels 353. The number of wheels for the crane frame 341, 342 can be designed to keep the wheel weights within the rail design limits of the facility. The attachment points on the main gantry 310 are located to provide crane stability in the “East/West” direction along the dock 330. The “North/South” crane stability results from the separate crane frame. A structural analysis of the existing gantry and the dynamic forces of the operations will determine the best points for the attachment.

FIG. 6 shows the preferred location of slip pins 344 and fixed pins and a detail of a slip pin.

The braces should be engineered to be as high as possible for crane stability. In FIG. 7, attachment points 361 are provided on frame 441 for opposite side installation. In FIG. 7, a rope luffing jib crane 411 replaces the hydraulic ram luffing crane 311 of FIGS. 4-6. Also, the separation of frame 441 from gantry 310 is greater than the separation of frame 342 from gantry 310 to give added stability and reach to crane 411.

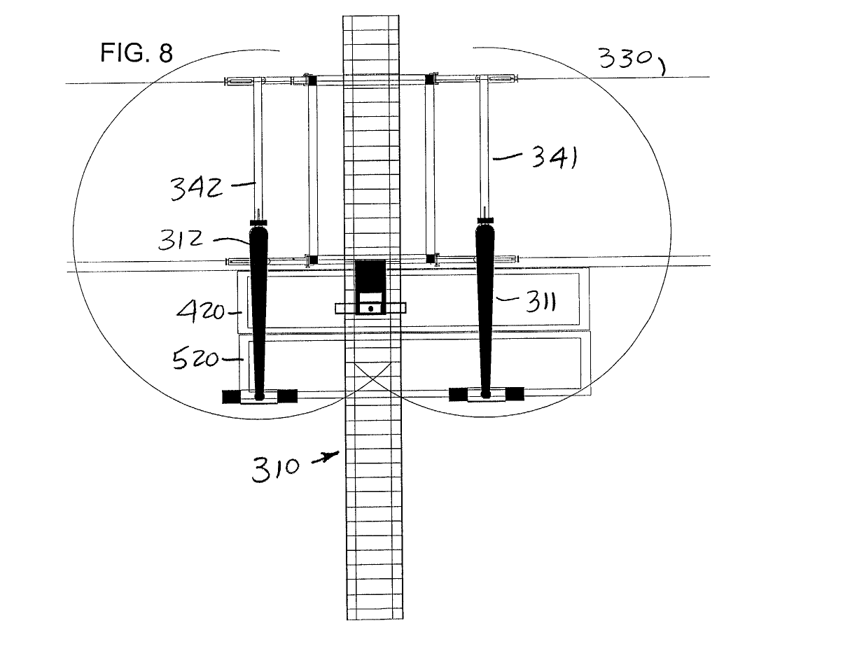

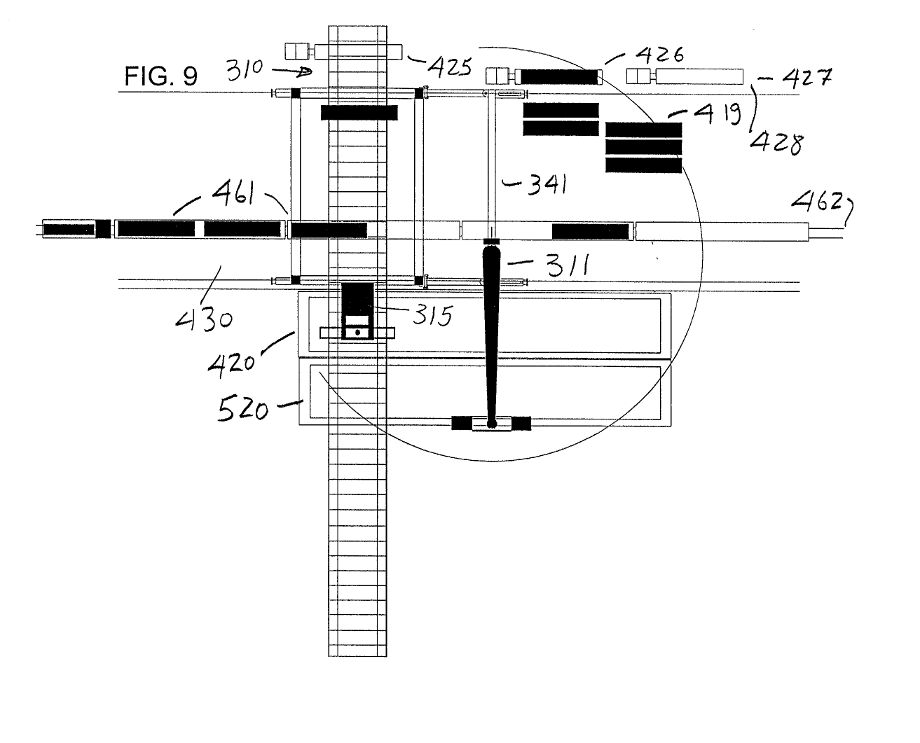

FIGS. 8 and 9 show the modified gantry 310 positioned over two standard hopper barges 420, 520. For barge and similar operations where the vessel(s) being loaded are without ballast and trim pumps, the modified gantries 310 are substantially more productive because the barge trim can be maintained during operations without gantrying up and down the length of the barge. Hopper barges 420, 520 can be 35 feet (10.7 m) wide and 195 feet (59.4 m) long, for example.

FIG. 9 shows a rail-on-dock operation 430. The boom crane 311 provides better reach to temporary stacks, trucks and train. The improved reach gives a terminal operator added flexibility to plan rail-on-dock operations efficiently.

In FIG. 9, a temporary storage stack 419 is indicated below the truck lanes 428. Three trucks 424, 426, and 427 are on the truck lanes 428. Railroad cars 461 or other like container-carrying means are on track 462.

In all plan views, the partial circles show the maximum outreach of the boom crane whose base is at the center of the partial circle.

The present invention has particular utility in the systems and methods disclosed in International Publication No. WO 01/42125 A1, which is incorporated herein by reference.

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. Apparatus including:
a gantry;
a gantry crane attached to the gantry;
at least one rotating boom crane attached to the gantry.

2. The apparatus of claim 1, including at least two rotating boom cranes attached to the gantry.

3. The apparatus of claim 1, wherein the gantry includes a ship side, and including at least one boom crane attached to the ship side of the gantry.

4. The apparatus of claim 1, wherein the gantry includes a back side, and including at least one boom crane attached to the back side of the gantry.

5. The apparatus of any prior claim, including three rotating boom cranes attached to the gantry.

6. The apparatus of any prior claim, including four rotating boom cranes attached to the gantry.

7. Apparatus including:
a gantry;
a gantry crane attached to the gantry;
at least one rotating horizontal slewing boom crane attached to the gantry.

8. The apparatus of claim 7, including at least two rotating boom cranes attached to the gantry.

9. The apparatus of claim 7, wherein the gantry includes a ship side, and including at least one boom crane attached to the ship side of the gantry.

10. The apparatus of claim 7, wherein the gantry includes a back side, and including at least one boom crane attached to the back side of the gantry.

11. Apparatus including:
a ship-to-shore gantry;
a gantry crane attached to the gantry;
a boom crane and frame attached to the ship-to-shore gantry.

12. Apparatus including:
a boom crane;
a frame for supporting the boom crane;
means for attaching the frame to a ship-to-shore gantry.

13. The apparatus of any prior claim, including three rotating boom cranes attached to the gantry.

14. The apparatus of any prior claim, including four rotating boom cranes attached to the gantry.

15. The apparatus of any prior claim, including at least one slewing boom crane attached to the gantry.

16. The apparatus of any prior claim, including at least one luffing boom crane attached to the gantry.

17. The apparatus of any prior claim, including at least one luffing boom crane attached to the gantry and at least one slewing boom crane attached to the gantry.

18. The apparatus of any prior claim, including two luffing boom cranes attached to the gantry and two slewing boom cranes attached to the gantry.

19. The invention(s) substantially as described and shown herein.
